(19) United States
(12) Patent Application Publication
(10) Pub. No.: US 2016/0315832 A1
(43) Pub. Date: Oct. 27, 2016

(54) COMMUNICATIONS SYSTEM, METHOD AND GATEWAY DEVICE

(71) Applicant: FUJITSU LIMITED, Kawasaki-shi (JP)

(72) Inventors: Bo HU, Winchester (GB); Zhaojun LI, Guildford (GB)

(21) Appl. No.: 15/087,708

(22) Filed: Mar. 31, 2016

(30) Foreign Application Priority Data
Apr. 27, 2015 (GB) 1507136.8

(51) Int. Cl. H04L 12/26; H04W 4/00; H04L 25/20; H04L 29/06

(52) U.S. Cl. CPC H04L 43/04; H04L 65/102; H04W 4/008; H04L 25/20; H04L 63/1433; H04L 63/06

(57) ABSTRACT

A communications system comprises a gateway device, a data server and neighbouring devices neighbouring the gateway device, wherein the gateway device is arranged to receive monitoring information from one or more sensors and to forward the monitoring information to the data server; the data server is arranged to receive the monitoring information; the communications system is arranged to generate an alert and initiate relaying if the connection between the gateway device and the data server is at risk; the gateway device is arranged to identify a relaying group of one or more neighbouring devices that can relay the monitoring information from the gateway device to the data server; and to send the monitoring information to the one or more neighbouring devices in the relaying group; each member of the relaying group is arranged to receive the monitoring information sent to it, and to relay the monitoring information to the data server; and the data server is arranged to receive the monitoring information.

The present invention relates to a communication system and method in which information sent to a gateway device is to be forwarded to a data server. The communication system and method may be used in a system where continuous communication is required between a gateway device and a data server or the like. An example of this may be a monitoring system, such as industrial process monitoring or remote monitoring in healthcare.

### BACKGROUND OF THE INVENTION

Many systems require continuous communication between a gateway device monitoring and forwarding information and a data server or the like. In some cases, for example, remote healthcare monitoring, continued communication can be critical. Remote healthcare monitoring requires continuous monitoring of individuals and is often used to monitor individuals outside of conventional clinical settings, for example, to monitor long term or chronic conditions (LTC) of an individual in their home or for bio-data monitoring. This monitoring can require vital information about an individual, such as heart rate, blood sugar levels, blood pressure, etc, to be continuously monitored and collected using wearable devices/sensors. Data is sensed or otherwise obtained by wearable devices/sensors and then sent to a remote server to be stored and accessed by a medical professional. Successful monitoring therefore requires, at the very least, reliable wearable devices/sensors, high availability of communication channels and high throughput data processing tooling. A typical architecture of such a continuous monitoring system is illustrated in FIG. 1.

FIG. 1 shows the network topology of a typical continuous monitoring system. The diagram depicts a gateway device communicating with a cloud data server via a base station in the communication network. The gateway device is a portable user device that is associated with an individual within the cellular communication system. The individual is wearing a number of wearable devices/sensors for measuring and sensing information about the individual. FIG. 1 also shows a number of neighbouring devices that are in close proximity to the gateway device and are capable of communicating with the cloud server via a multi-mode small cell in the communication network.

In such a system it is common that multiple wearable devices/sensors are attached to a subject individual to constantly collect information (often biological information) about them. The size and power consumption of the devices/sensors is restricted because it is required that the devices/sensors are wearable and so comfort and convenience for the wearer are key design factors. Such devices/sensors are therefore usually only equipped with very limited data processing capacity. This may also be true in industrial monitoring situations, where small and/or heat or shock-proof in-situ sensors may be required. As a result, a gateway device may be used to act as an intermediate data collection and pre-processing unit. Power consumption restraints on the devices/sensors dictate that the gateway device may be presented in close proximity to the devices/sensors. In one common arrangement, the gateway device is a mobile phone.

The gateway device can package and transmit data to a remote data server (potentially via a base station) for further processing and/or storing. Thus, in the LTC or other medical scenario, the gateway device can act as the main, and often only, data gateway that collects monitoring data from wearable devices/sensors and transfers the collected monitoring data to a remote data server. Data transmission from the gateway device to the remote data server is possible over existing communication networks, for example, a cellular mobile communication network and/or Wi-Fi hotspots (or home networks).

The gateway device may receive data/information that is sensed, measured or otherwise obtained by monitoring devices/sensors. The gateway device can then package the received data/information. The packaging of the data/information may depend on the particular data/information itself and/or an application being run on the gateway device and/or the communication network, and may include compressing and/or encrypting the data/information. The gateway device can then transmit the packaged data/information to a data server. The packaged data/information may be transmitted directly to the data server via a suitable communication link/network or may be transmitted via a base station present in the communications system/network.

The data server can receive packaged data/information transmitted by the gateway device, either directly or via a base station. The data server may be provided in the form of cloud storage or some other data analytics server that is capable of extracting, storing and possibly analysing data/information. The data server may be remote or local to the gateway device. In some circumstances, it may be possible for the data/information to be accessed by a third party, such as, for example, a medical professional.

A continuous monitoring system (such as that depicted in FIG. 1) can be interrupted and disturbed by many factors. Interruption in continuous monitoring can lead to failures of the system and, in remote healthcare monitoring and LTC, it can lead to failures in high quality healthcare service provision. In industrial process monitoring, the loss of continuous monitoring can lead to failures of the process or unacceptable process conditions.

Embodiments of the present invention focus on the situation of transmission problems, for example, when the front line data sensing at the wearable devices/sensors and subsequent transfer to the gateway device is functional but the gateway device becomes temporarily unable to transfer the data to the data server. Such a situation may arise when the gateway device itself is low in power supply, or the network connection with the data server is weak or lost (for example, due to poor network coverage). It is therefore desirable to provide a communications system and method which ensures that data transfer between the gateway device and the data server can be maintained even when communication between the gateway device and the data server is at risk of being lost.

Embodiments of the invention try to address such a situation through a data relay methodology that can i) reduce power consumption of the gateway device, for example, in comparison to direct communication with the remote server, and/or ii) ensure data quality through duplication, and/or iii) enhance data security through fragmentation and anonymised communication.

According to an embodiment of one aspect of the invention, there is provided a communications system comprising a gateway device, a data server and neighbouring devices neighbouring the gateway device, wherein the gateway device is arranged to receive monitoring information from one or more sensors and to forward the monitoring information to the data server; the data server is arranged to receive the monitoring information; the communications system is arranged to generate an alert and initiate relaying if the connection between the gateway device and the data server is at risk; the gateway device is arranged to identify a relaying group of one or more neighbouring devices that can relay the monitoring information from the gateway device to the data server and to send the monitoring information to the one or more neighbouring devices in the relaying group; each member of the relaying group is arranged to receive the monitoring information sent to it, and to relay the monitoring information to the data server; and the data server is arranged to receive the monitoring information.

Thus it is possible to maintain communication and data transfer between the gateway device and the data server by initiating a relay stage in which information and data is relayed from the gateway device to the data server via the relaying group of the neighbouring devices. Single device relaying is not excluded from the embodiments and the relaying group of neighbouring devices may contain only one neighbouring device or it may contain more than one neighbouring device. When this methodology is used in a monitoring system, it is possible for the monitoring data to continue to be transferred to the data server without being interrupted, even if there is a risk of the direct communication between the gateway device and data server being lost. The period in which there is a risk of the direct communication between the gateway device and data server being lost may be referred to as an interruption period, T_{S}.

Used in the scenario of remote healthcare monitoring described above, the present invention allows for the continued transfer of the monitoring data/information of the individual from the gateway device to the data server without inconveniencing the individual. In situations such as remote healthcare monitoring, a loss of communication between the gateway device and the data server would most likely result in vital monitoring information not being transferred to the data server, which could prove damaging to the health of the individual and, in some cases, may potentially even be critical. The present invention allows for the monitoring data/information to continue to be transferred from the gateway device to the data server and therefore reduces and possibly eliminates any risk that there may have been to the individual being monitored.

Healthcare and remote monitoring of individuals is used by way of example only and the present invention is not limited to healthcare monitoring. Accordingly, the monitoring data/information is not limited to wearable devices/sensors and may be any form of data/information that is sensed or otherwise obtained from one or more devices/sensors in a system. The communication system and method can be used in any system where continuous communication between a gateway device and a data server, or a similar device, is required.

A neighbouring device may be a mobile phone, a smart phone, tablet computer, PDA or other portable user device. A neighbouring device may also be a fixed relay station in the, or another, network. A device may be classified as a neighbouring device if it is located within close proximity of the gateway device, particularly at a time when a relay stage is initiated. Devices in close proximity to the gateway device may be defined as devices which are close enough to the gateway device. For example, the required transmission power for the gateway device to communicate with the neighbouring device may be less than the required transmission power for the gateway device to communicate with the data server, either directly or via a base station. Alternatively, a device may be classified as neighbouring if the gateway device and the device can communicate using short-range wireless technology, as explained in more detail hereinafter.

In a situation where a neighbouring device that is acting as a relaying device as part of the relaying group is no longer in close proximity to the gateway device and is no longer considered a neighbouring device, the relaying device may be removed from the relaying group and as such, the gateway device will not continue to communicate with the former neighbouring device. Accordingly, the relaying devices of the relaying group may change or may remain the same throughout the relay stage. If a neighbouring device is removed from the relaying group, it may or may not be replaced with a new neighbouring device, provided that the relaying group contains one or more neighbouring devices.

The relaying group may also contain more than one neighbouring device. In this situation the gateway device is arranged to identify a relaying group of two or more neighbouring devices that can relay the monitoring information from the gateway device to the data server. The gateway device is further arranged to divide the monitoring information into segments and to send each of the segments to a subset of the neighbouring devices in the relaying group. Each member of the relaying group is arranged to receive the one or more segments of the monitoring information that are sent to it, and to relay the received segments to the data server. The data server is then arranged to receive the segments and to combine the segments to acquire the monitoring information.

However, it is not required for the relaying group to have two or more neighbouring devices. The single one-to-one communication still fits the scenario, as communicating with a device in the close proximity will save the energy of the initiating device.

For security purposes, the security component of the data server may be arranged to create a public and private key pair in response to the generated alert that the connection between the gateway device and data server is at risk. The public key may then be sent to the gateway device and the gateway device is arranged to encode the monitoring information with the public key, before the monitoring information is sent to the neighbouring devices of the relaying group. When the data server receives the encoded monitoring information, it is arranged to decode the monitoring information using the private key. If the relaying group comprises more than one neighbouring device, each segment of the monitoring information is encoded with the public key before being sent to a subset of the neighbouring devices in the relaying group. Accordingly, upon receipt, the data server is arranged to decode each segment using the private key, before combining them to acquire the monitoring information.

For increased reliability of the system, it is preferable that the relaying group contains two or more neighbouring devices and that the monitoring information is relayed to the data server by more than one relaying device in the relaying group. In the preferred embodiment, the segments of monitoring information are sent to a subset of (not all of) the relaying group and each member of the relaying group receives the segment(s) of monitoring information sent to it and relays the information to the data server. Accordingly, it is also preferable for each subset in the communication system to include more than one neighbouring device, and for the subsets to differ so that no neighbouring device receives all the segments of the monitoring information. Thus, to avoid a single neighbouring device obtaining all of the monitoring information or healthcare data, it is preferable that the relaying group is split into a number of different subsets so that the segments of the monitoring information may be split between the various subsets of the relaying group.

For increased security in the system, it is preferable that a shared key is generated for use by the relaying group and gateway device. The gateway device is arranged to encode each segment with the public key and with the shared key; and each member of the relaying group is arranged to decrypt the data using the shared key before transmission to the data server. The shared key may be generated by the gateway device and shared with the neighbouring devices in the relaying group. Alternatively, the shared key may be generated by the data server and the generated shared key may then be sent to the gateway device to be distributed to the relaying group. As stated above, it is preferable that each segment of the monitoring information is encrypted with the public key and the shared key before being transmitted to the relaying devices of the relaying group. The information may then be partially decrypted by each relaying device using the shared key before being relayed to the data server. The information may then be fully decrypted at the data server using the previously generated private key.

Public and private keys may be used for the communication between the gateway device and the data server. Since the server would hold the private key, data may then only be decrypted and consumed by the server. A shared key may be used by all the devices involved in the relaying process, including the gateway device and/or neighbouring devices. The shared key may therefore provide an extra layer of security.

It is preferable in the communication system that the gateway device is arranged to identify if the connection between the gateway device and the data server is at risk of being lost using a periodical health check which assesses current battery charge and expected battery-usage. The periodical health check may be carried out on the gateway device, by the gateway device. The periodicity with which the health check algorithm is carried out may be determined by an application running in the gateway device or by user activity. The periodicity may additionally or alternatively be dependent on the location of the gateway device and the battery-usage.

Furthermore, it is preferable that the periodical health check takes into account one or more of: a battery level of the gateway device; power consumption of any essential system applications of the gateway device; power consumption required to maintain communication with the sensor; and power consumption required to maintain communication with the data server. It may be that a combination of the above listed factors determines whether or not the connection between the gateway device and the data server is at risk of being lost, and therefore whether or not the relay stage is initiated.

The periodical health check may take into account a battery-usage prediction model to decide whether to initiate relaying. The battery-usage prediction model may be based on current battery-usage or historical battery-usage or both. For example, heavy usage today and/or a pattern of increased usage at a particular time each day will affect how long the connection might be continued, as well as baseline factors showing expected battery usage and remaining charge in the health check.

Preferably, generation of the alert and initiation of the relay stage when the connection between the gateway device and the data server is at risk of being lost take into account one or both of: historical power consumption of the gateway device; and location of the gateway device. As mentioned above, other factors may include, for example, current power consumption and the results of the health check algorithm.

Relaying may be initiated based on whether the connection will be lost using a current battery-usage based prediction, and/or a historical battery-usage based prediction to provide an estimate of remaining battery life. The estimate may be compared with a threshold to judge if the connection will be lost. The threshold (for example, in terms of remaining estimated battery life) may be determined by settings in an application running in the gateway device or by user input. The threshold may also be determined by calculation according to various factors, such as, for example, the location of the gateway device and the amount of data being sent to the gateway device. For example, the threshold value to which the estimated remaining battery life is compared could be one hour if the gateway device is within the user's residence and therefore not far from known power supply location(s). If the gateway device is not within the user's residence and is therefore likely to be further from known power supply location(s), then the threshold may be set higher (for example, three hours) and the alert may then be issued earlier. That is, the alert may be issued at a time when the estimated remaining battery life is greater, compared with the situation when the gateway device is located within the user's residence.

Furthermore, it is preferable that both a current battery-usage based prediction and a historical battery-usage based prediction are used. In this case the threshold may be adjusted if the current battery-usage deviates from the pattern of historical battery-usage.

In summary, the threshold may be adjustable or fixed. The threshold may be adjusted by taking into account such factors as the current (or expected) battery-usage in comparison with the historical battery-usage and also the activity of the user.

The historical and/or current battery-usage based predictions can also include location of an individual being monitored. The prediction whether the connection will be lost can hence take into account the location of the individual. Specifically, factors such as the distance which the individual is from (a) power supply location(s) and/or from a base station may be considered when taking the location of the individual into account.

Preferably, the gateway device is arranged to identify the relaying group of one or more neighbouring devices that can relay the monitoring information from the gateway device to the data server by broadcasting a handshaking request and deriving neighbour information from responses of candidate neighbouring devices that respond. The neighbour information may be used to select neighbouring devices in the relaying group from the candidate neighbouring devices. Thus, the gateway device may identify candidate neighbouring devices from those devices nearby which respond to a handshake request. The gateway device may then select one or more neighbouring devices from the candidate neighbouring devices as the relaying group. The selection of the relaying group devices may be based on the neighbour information which is derived from responses to the handshake request.

The neighbour information derived from each neighbour response may include one or more of: signal strength of the response; battery life of the candidate neighbouring device; network carrier used by the candidate neighbouring device; distance between the gateway device and the candidate neighbouring device; and operating system of the candidate neighbouring device. Thus one or more of the above listed factors may determine which of the candidate neighbouring devices are selected as the relaying group. One device of the relaying group may be selected using the same factors or different factors from those listed above as another selected device, i.e. the same factors may or may not be used to select all relaying devices in the relaying group and so the selection of different devices in the relaying group may be based on the same or different neighbour information. The derived neighbour information may also include the type of candidate neighbouring device, for example, the candidate neighbouring device may be a portable user device or it may be a fixed relay station in the, or another, network. The type of neighbouring device may be considered, along with the above listed factors, when selecting the relaying group or a fixed relay device may take priority over other neighbouring devices.

The candidate neighbouring devices that respond to the handshaking request are ranked giving higher comparative scores to candidate neighbouring devices with longer battery life, stronger signal strength, shorter distance to the gateway device and an operating system compatible with the gateway device than other candidate neighbouring devices. The candidate neighbouring devices may be ranked so that one or more of the higher ranking devices may be selected as the relaying group. The relaying group may be periodically reviewed and refreshed throughout the relay stage. That is, the suitability of the neighbouring devices to act as relaying devices of the relaying group and their ranking according to the above listed attributes may be periodically reassessed by the gateway device. Thus the relaying group may or may not consist of the same neighbouring devices throughout the relay stage. If fixed relay stations are present, the power consumption based criteria will stay the same. The existence of fixed stations may be used in addition to or alternatively to other filtering/sorting criterion algorithms discussed herein.

Preferably, the candidate neighbouring devices that respond but are beyond a boundary distance from the gateway device are not ranked. Thus, devices that respond to the handshaking request but are beyond a boundary distance from the device may not be considered as candidate neighbouring devices. The boundary device may be pre-determined by the system, or may be dependent on other factors such as settings in an application running in the gateway device.

In one preferred embodiment, pre-relaying communication between the gateway device and the data server is via a base station. Relaying communication between at least one of the neighbouring devices and the data server may also be via a base station (and hence use cellular communication technology). That is, communication between the gateway device and the data server before the relay stage may be initiated via a base station (and in fact the relay stage may be used only infrequently). Additionally or alternatively, communication between one or more of the relaying group during the relay stage may be via a base station.

It is preferable that the gateway device is a mobile communications device, such as a mobile telephone, smart phone, tablet computer, PDA or other user device. The transmission to the neighbouring devices may be via short-range wireless technology (in which signals travel from a few centimetres to several metres, such as Bluetooth, Bluetooth low energy, infrared (IR), IEEE802.15 networks, ZigBee or Wi-Fi. The transmission to the neighbouring devices may be by any suitable wireless technology, taking into account such factors associated with the communication method, such as range, transmission power, interference and compatibility with other devices.

The candidate neighbouring devices may also be any suitable mobile communications device, including a mobile phone, smart phone, tablet computer, PDA or other user device. In one preferred embodiment, at least one of the neighbouring devices is a mobile communications device, such as a user device, for example mobile telephone, smart phone, tablet computer, PDA or other user device. The candidate neighbouring devices may also include one or more fixed relay stations in the communications system.

Invention embodiments also extend to a method carried out in the communications system as defined hereinbefore. Thus in an embodiment of a further aspect of the invention, there is provided a method of providing consistent monitoring via a communications system, comprising a gateway device sending monitoring information received from a sensor to a data server, wherein if the connection between the gateway device and the data server is at risk of being lost, relaying is initiated, in which relaying: the gateway device identifies a relaying group of one or more neighbouring devices that can relay the monitoring information from the gateway device to the data server; the gateway device sends the monitoring information to the one or more neighbouring devices of the relaying group; each member of the relaying group sends the monitoring information it has received to the data server; and the data server receives the monitoring information.

The invention extends to apparatus aspects of the system. The skilled reader will appreciate that the previously described system features and sub-features can apply in any combination to any of these apparatus aspects of the system.

Invention embodiments also extend to a gateway device in the communications system as defined hereinbefore. According to an embodiment of a still further aspect of the invention, there is provided a gateway device in a communication system, the system comprising the gateway device, a data server and neighbouring devices neighbouring the gateway device, wherein the gateway device includes a receiver arranged to receive monitoring information from a sensor and a transmitter arranged to forward the monitoring information to the data server; the gateway device includes a controller arranged to identify a relaying group of one or more neighbouring devices that can relay the monitoring information from the gateway device to the data server; and the gateway device transmitter is arranged to send the monitoring information to the one or more neighbouring devices of the relaying group.

Preferably, the gateway device controller is arranged to identify if the connection between the gateway device and the data server is at risk of being lost and if so to trigger a relay stage and generate an alert which is sent to the data server. The alert can be any signal which indicates that a relays stage is to be initiated.

In a corresponding method embodiment, there is provided a method in a gateway device of a communication system, the system comprising the gateway device, a data server and neighbouring devices neighbouring the gateway device, the method including receiving monitoring information from a sensor and forwarding the monitoring information to the data server; identifying a relaying group of one or more neighbouring devices that can relay the monitoring information from the gateway device to the data server; and sending the monitoring information to the one or more neighbouring devices of the relaying group.

According to a further aspect there is provided a program which when loaded onto a communication system or mobile device configures the device to carry out the method steps according to any of the preceding method definitions or any combination thereof.

The invention can be implemented in digital electronic circuitry, or in computer hardware, firmware, software, or in combinations of them. The invention can be implemented as a computer program or computer program product, i.e., a computer program tangibly embodied in an information carrier, e.g., in a machine-readable storage device or in a propagated signal, for execution by, or to control the operation of, one or more hardware modules. A computer program can be in the form of a stand-alone program, a computer program portion or more than one computer program and can be written in any form of programming language, including compiled or interpreted languages, and it can be deployed in any form, including as a stand-alone program or as a module, component, subroutine, or other unit suitable for use in a communication system environment. A computer program can be deployed to be executed on one module or on multiple modules at one site or distributed across multiple sites and interconnected by a communication network.

The invention is described in terms of particular embodiments. Other embodiments are within the scope of the following claims. For example, the steps of the invention can be performed in a different order and still achieve desirable results.

The apparatus according to preferred embodiments is described as configured or arranged to carry out certain functions. This configuration or arrangement could be by use of hardware or middleware or any other suitable system. In preferred embodiments, the configuration or arrangement is by software.

Elements of the invention have been described using the term “controller”, “receiver” and “transmitter”. The skilled reader will appreciate that these terms and their equivalents may refer to parts of the gateway device, neighbouring devices or data server that are spatially separate but combine to serve the function defined. Equally, the same physical parts of the gateway device, neighbouring devices or data server may provide two or more of the functions defined.

For example, separately defined functions of the controller may be implemented using the same memory and/or processor as appropriate. The transmitter and receiver may be implemented separately or as a transceiver.

Features and sub-features of the system and apparatus aspects may be applied to the method aspects and vice versa.

### BRIEF DESCRIPTION OF THE DRAWINGS

Reference is made, by way of example only, to the accompanying drawings in which:

FIG. 1 is a previously described schematic diagram showing the network topology of a typical continuous monitoring system;

FIG. 2 is a system diagram representing a general embodiment of the invention;

FIG. 3 is a flowchart representing a general embodiment of the invention;

FIG. 4 is a signalling diagram between a gateway device, a data server and neighbouring devices for a detailed embodiment of the invention;

FIG. 5 is a schematic diagram illustrating a gateway device and neighbouring devices according to an embodiment of an aspect of the invention; and

FIG. 6 is a system block diagram representing a general embodiment of the invention.

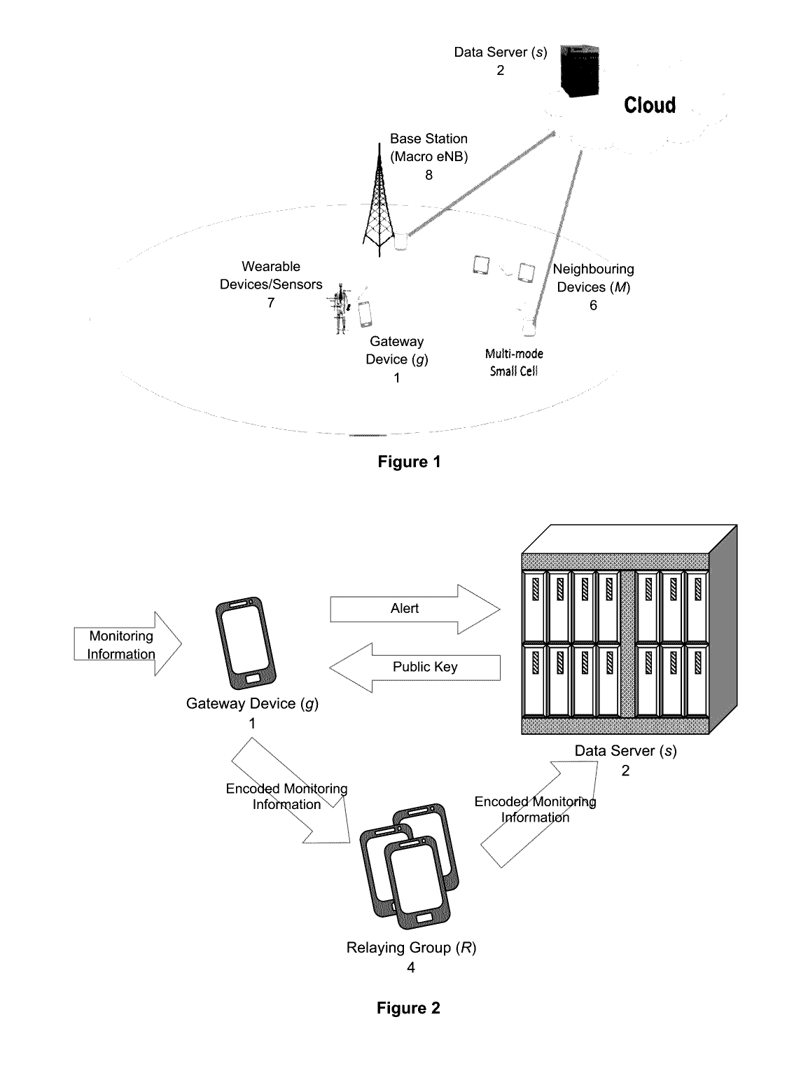

FIG. 2 shows a system diagram of a general embodiment of the present invention when the relay stage is initiated. The gateway device transmits an alert to the data server, which indicates that the connection between the gateway device and the data server is at risk and thus initiates the relay stage. In acknowledgement of the alert, the security component of the data server may create a public and private key pair and transmit the public key to the gateway device. The initial notification between the gateway device and the data server is necessary for the data server to accept data from other devices. Other routes of communication may otherwise be considered intrusion.

A relaying group of one or more neighbouring devices is then identified by the gateway device to relay the monitoring information from the gateway device to the data server. The monitoring information is received by the gateway device from one or more sensors or measuring devices (sensors/devices not shown in FIG. 2). In a situation where the relaying group contains two or more neighbouring devices, the gateway device divides the monitoring information into segments and encodes each segment using the public key issued by the data server. Each of the segments of the encoded monitoring information is then transmitted to a subset of the relaying devices of the relaying group.

Each of the relaying devices in the relaying group receives the segments of encoded monitoring information that are sent to it and relays the segments to the data server. The data server then receives the segments from all of the relaying devices in the relaying group. The segments of the encoded monitoring information are then decoded and combined by the data server using the private key to acquire the monitoring information.

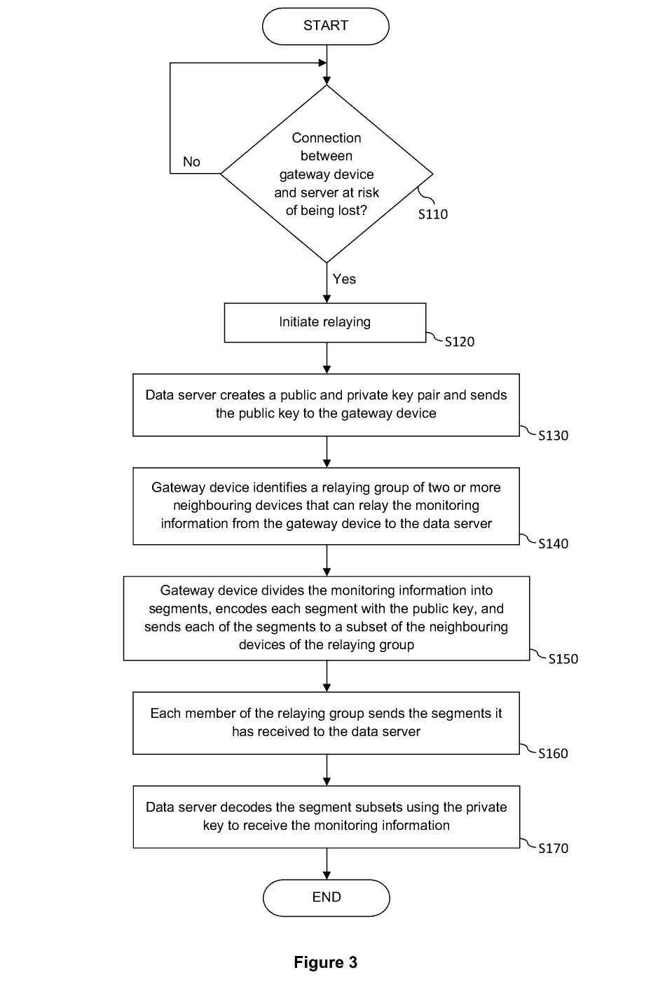

FIG. 3 is a flowchart representing a general embodiment of the invention where consistent monitoring via a communications system comprises a gateway device receiving monitoring data/information from a sensor/measurement device and sending it to a data server.

In step S110 it is determined whether the connection between the gateway device and the data server is at risk of being lost. If the connection is at risk then the relay stage is initiated in step S120. In step S130, the data server creates a public and private key pair, with the public key being sent to the gateway device. In the next step, S140, a relaying group consisting of two or more neighbouring devices is identified by the gateway device. The neighbouring devices in the relaying group are capable of relaying the monitoring information from the gateway device to the data server. The gateway device then divides the monitoring information into segments in step S150. Each segment is encoded with the public key and each of the segments are sent to a subset of the neighbouring devices of the relaying group. In step S160 each member of the relaying group sends the segments it has received to the data server. The data server then decodes the segment subsets using the private key to receive the monitoring information in step S170.

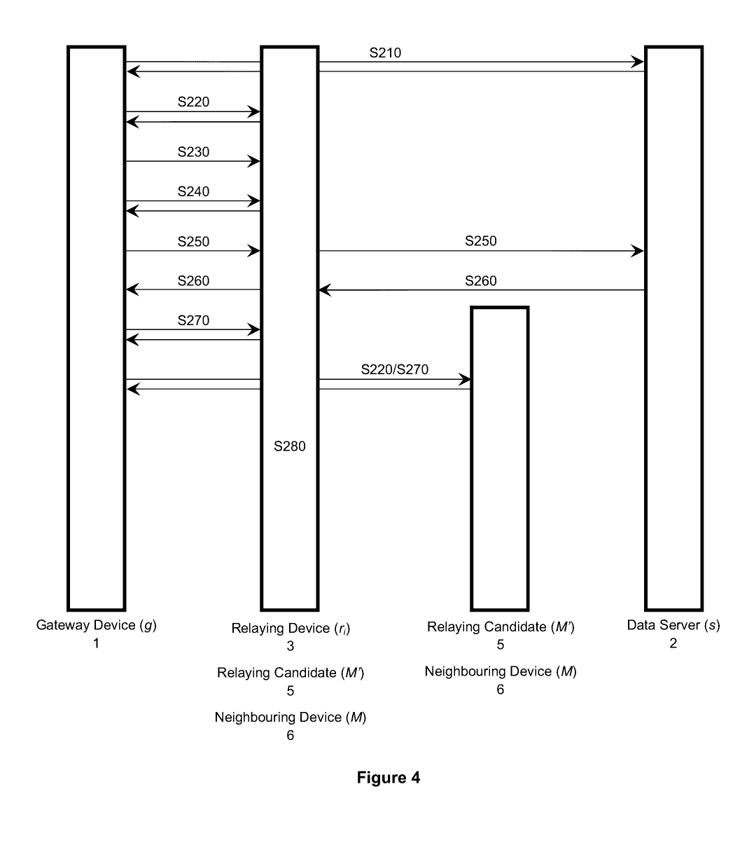

FIG. 4 shows a signalling diagram of the communications between a gateway device, a data server and neighbouring devices for a detailed embodiment of the invention, when the relay stage is initiated. It is assumed that the sensing and acquiring of the monitoring information by the sensors and subsequent transfer to the gateway device remains uninterrupted throughout an interruption period, i.e. although the connection between the gateway device and the data server may be lost or at risk during the interruption period, the connection between the sensor(s) and the gateway device is not lost or interrupted during this period.

Once the interruption period has ended and the connection between the gateway device and the data server is recovered or no longer at risk, the network communication may be resumed. That is, the connection and communications between the gateway device and the data server will return to their normal state, i.e. they will revert to the connection that was present before the relay stage was initiated.

In this embodiment, in order for the gateway device to initiate the relay stage and identify neighbouring devices and select a relaying group, it is required that the gateway device is able to detect and utilise its own status and (through the network) the status of communication devices within a close proximity (neighbouring devices). Modern mobile phones or smart phones, equipped with sufficient computational power, are able to collect data, for example, through short-range wireless networking technology (e.g. Bluetooth) and/or to offload data onto local non-volatile storage. Nowadays, “smart” mobile phones are able to conduct self “health check”, often through software, such as application programming interfaces (APIs) offered by the underlying operation system of the device (for example Android or iOS). At the application level, handshaking messages can be used to discover neighbouring devices.

According to embodiments of the invention, communications between a gateway device and a data server are relayed through a subset of neighbouring devices within close proximity of the gateway device. The detailed embodiment depicted in FIG. 4 is explained, by way of example only, below.

FIG. 4 shows communications between a gateway device (g) and server (s) relayed through a subset of neighbouring devices (M) within close proximity of the gateway. The communication is established as follows:

In step S210, it is determined that the communication between the gateway device and the data server is at risk and so the relay stage is initiated. The communication between the gateway device and the data server may be put at risk by a number of factors, such as, for example, low power supply in the gateway device itself or the network connection with the data server being weak or lost (for example, due to poor network coverage). The period in which the communication between the gateway device and data server is at risk may be referred to as an interruption period, T_{S}.

The risk to the communication between the gateway device and the server is determined by a health check algorithm in the gateway device. The health check algorithm determines that the communication is at risk and issues an alert to trigger the relay stage. In this case, the relay stage is initiated by the gateway device which communicates with the data server in order to sign off properly. In response to the alert, the data server generates a public and private key pair key. The public key (pk) is sent back to the gateway device, together with an acknowledgement that the relay stage is starting.

In step S220, the gateway device identifies a subset of the neighbouring devices as the relaying candidates (M′) for the relaying of the monitoring information, using responses to an initial handshaking message. The relaying candidates are identified using a relay selection algorithm, which will be discussed in more detail later.

In step S230, the gateway device broadcasts to the relaying candidates (M′) a handshaking message with a request for status information of the relaying candidates. The status information of the relaying candidates can be used to determine which of the relaying candidates will be selected as relaying devices (rᵢ).

Alternatively, the handshaking requests in steps S220 and S230 may be a single handshaking message with a status information request rather than two separate handshaking requests.

In the next step, step S240, a first group of neighbouring devices is identified by the gateway device as a relaying group to relay the monitoring information to the data server from the gateway device. The relaying group comprises two or more relaying devices (rᵢ) from the relaying candidates of the neighbouring devices. The relaying group is identified using the relay selection algorithm and the status information of the relaying candidates which is sent to the gateway device from the relaying candidates in response to the handshaking message in the previous step. The selection process will be discussed in more detail later. A shared encryption key is then generated and distributed among the relaying devices of the relaying group.

In step S250, the gateway device partitions the monitoring information into a number of segments (K segments), where the number of segments is greater than the number of relaying devices (K>M). K being greater than M means that the size of each segment can be reduced and/or the number of replicas can be increased so that the communication demand for each segment will not be too high. The gateway device then encrypts the segments of the monitoring data/information with the shared key and the public key to give D′ᵢ=sk(pk(Dᵢ)) (where 0<i<K). The encrypted segments D′ᵢ are then sent by the gateway device to a subset of the relaying devices in the relaying group. Each recipient of the encrypted segments of data D′ᵢ then partially decrypts the data with the shared key (sk) and relays the partially encrypted data pk (Dᵢ) to the data server, in accordance with its security agreement with the data server. The security agreement between the relaying device and the data server may be established when the neighbouring device responds to the handshaking request or when the neighbouring device is selected as a relaying device. The data/communication security between a relaying device and the data server may also be arranged when the devices opt in to the scheme. Any of these alternatives may be achieved by installing an application on the neighbouring device or accepting a certain security certificate.

Thus each segment of the monitoring data/information is relayed to the data server by more than one relaying device in the relaying group. Different segments of the monitoring data/information can be sent to different subsets of the relaying group so that no single relaying device receives all of the monitoring data/information.

In step S260 an acknowledgement (ACK) is sent back to the relaying device from the data server and is then relayed to the gateway device. The acknowledgment indicates the successful delivery of the segment of the monitoring data/information to the data server, with a replication factor which is based on the number of relaying devices in the subset of the relaying group and is defined by the application. That is, the replication factor is the number of times that each segment of data is received by the data server. Providing that each relaying device in the subset successfully relays the segment to the data server, the replication factor will therefore be determined by the number of relaying devices in the subset.

Step S270 is a periodic handshake and health check which is conducted on the relaying group by the gateway device. This is to determine whether the relaying devices in the relaying group are still suited to relay the monitoring information to the data server. If |Rᵢ|≦λ (where Rᵢ is the number of relaying devices in the relaying group and λ is a predefined threshold), an alternative relaying group is selected and the process is repeated from step S220 with the new relaying group. Any data packages that did not receive an ACK will be present in the newly established ad hoc network. Thus the relaying group may or may not remain the same and consist of the same neighbouring devices throughout the relay stage.

In step S280, for each relaying device in the relaying group, if after a predetermined period of time (t′), the relaying device has not received an ACK from the data server and/or has not received a handshaking message from the gateway device, it is assumed that the neighbouring device is no longer a relaying device. The neighbouring device will therefore no longer continue to relay data to the data server and all data packages from the gateway device will be deleted. Neighbouring devices which have not been selected as relaying devices but may still locally hold data packages relating to the process, (for example, neighbouring devices that respond to the initial handshaking request from the gateway server and neighbouring devices selected as relaying candidates) will also delete any data packages relating to the process if, after a predetermined period of time (t′), no communication is received from the gateway device and/or the data server. The status is as follows: if no periodical handshake is received, the neighbouring device is out of touch with the gateway device; and/or if a neighbouring device has not received an ACK message from the data server, the communication with the data server is probably lost or no longer required. For safety reasons, data packages held on the neighbouring device should be deleted with the assumption that the neighbouring device is not taking part in the message relaying process.

The process is continued throughout the relay stage. The health check algorithm on the gateway device continues to run during the relay stage. If the health check algorithm determines that the communication between the gateway device and the data server is no longer at risk, then the interruption period has ended and so the relay stage is ended. The gateway device then communicates directly with the data server to re-establish the connection and the system reverts to its normal operation with the monitoring information being sent directly to the data server (possibly via a base station).

As stated above, the health check algorithm is present in the gateway device and is used to determine whether the communication between the gateway device and the data server is at risk and thus, whether constant monitoring can be carried out. The health check algorithm is run periodically in the gateway device. The periodicity with which the health check algorithm is run can depend on one or more factors, such as, for example, by an application running in the gateway device, by user activity, the location of the gateway device or the battery-usage.

The health check solicits system information, such as current battery charge and expected battery usage, which can be used to predict whether constant monitoring can be sustained. The acquired system information may include the following:
1. Remaining battery of the gateway device;
2. Essential system applications and their unit power consumption;
3. The power consumption required for maintaining the monitoring network and sustained communication with monitoring sensors/devices; and/or
4. The power consumption required for maintaining communication with the data server (possibly via a base station).

The periodical health check may also use a battery-usage prediction model to determine whether the connection between the gateway device and the data server is at risk. The prediction model can be based on several types of data source, some examples of which are shown in the sections below.

Current battery-usage based prediction: the power consumption rate can be computed based on the above data. The remaining battery life lₑ can then be concluded and compared with a predefined threshold top determine whether constant monitoring can be maintained. If the remaining battery life is lower than the predefined threshold, it is determined that the connection between the gateway device and the data server is at risk and so the device should enter the data relay stage. The calculation of the remaining battery life can be based on simple linear equations, using acquired system information, such as that listed above.

Historical battery-usage based prediction: by collecting usage patterns of a subject individual, a more accurate prediction model can be obtained. For instance, if a long mobility period always presents in the individual's daily routine, the system/application should be able to determine whether and when the individual has access to power. The system/application can then decide whether the device should enter the data relay stage by adjusting the predefined threshold with which the remaining battery life is compared according to the historical battery-usage.

When the current activity deviates from the daily routine established by the historical battery-usage based prediction and the current remaining battery life has not yet reached a sufficiently low level to initiate the relay stage, the system/application may decide whether the device should enter the relay stage ahead of the thresholds set by the current battery-usage and historical battery-usage based predictions.

Combined with other types of sensor data (for example, mapping and/or GPS data) where available, the system/application may detect whether the gateway device is out of reach of expected power supply (for example, the subject individual is outdoors or in any other area which is determined to have restricted power supply). If the gateway device is located in an area that is expected to be out of reach of power supply, the system/application may instruct the device to enter the relay stage. This may be earlier than according to the thresholds set by the current battery-usage and historical battery-usage based predictions. Thus, the location of the gateway device can be used to determine whether the relay stage is initiated.

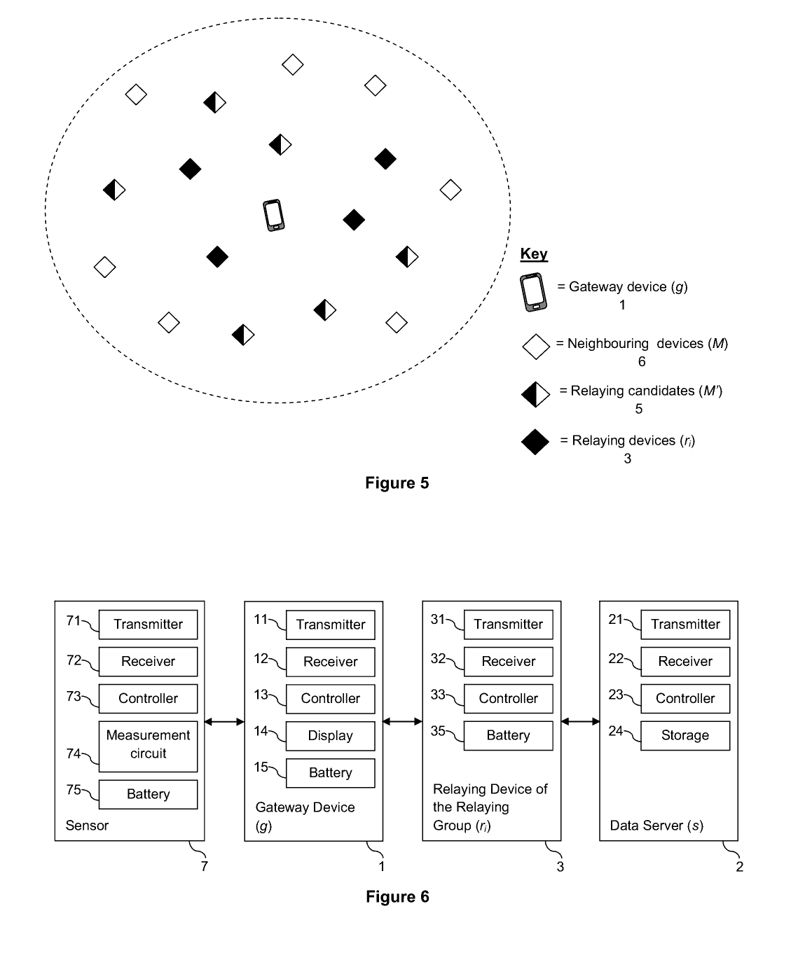

FIG. 5 is a schematic diagram illustrating a gateway device and neighbouring devices according to an embodiment of the invention. A process for the selection of the relaying devices, from the relaying candidates of the neighbouring devices will be discussed, with reference to FIG. 5.

FIG. 5 shows an example scenario of a gateway device in an area with a number of neighbouring devices when the relay stage has been initiated. As can be seen, a number of the neighbouring devices have been identified as relaying candidates and from the relaying candidates, four relaying devices have been selected to form the relaying group.

The gateway device needs to identify appropriate candidate relaying devices from the neighbouring devices and also to detect the dynamic changes among the candidates. As stated above, a relay selection algorithm is used to identify the relaying candidates and select the relaying group.

After entering the relay stage, the gateway device g starts to discover devices that are within close proximity by broadcasting an initial handshake request. The neighbouring devices with which the gateway device establishes a communication channel become the relaying candidates. The gateway device then detects the basic physical layer information of the relaying candidates. This can be achieved either by broadcasting another handshaking message requesting system information or by using responses to the initial handshaking message requesting system information. The gateway device detects information, such as signal strength (Sig), as well as retrieving other basic information from the relaying candidates, including, for example, battery life (Bat), network carrier (NC), distances (based on coordinates) (L), operating system (OS), etc.

A scoring method ranks the relaying candidates by computing an integrated score which takes all the different features into consideration. The top Rᵢ relaying candidates are selected for further communication as the relaying devices. Rᵢ is therefore the number of relaying devices in the relaying group and may consist of two or more devices. An exemplary ranking implementation is shown in equation 1 below and may be based on a weighted average, with weights α, β, τ and ƒ giving higher scores to candidates with longer battery life Batᵢ, stronger signal reception Sigᵢ, shorter distance Lᵢ (to the gateway device g), and compatible operating system OSᵢ and network carrier NCᵢ.

score(rᵢ)=α·Batᵢ+β·Sigᵢ+τ·Lᵢ+f(OSᵢ, NCᵢ) (1)

Note that distance may be normalised against a pre-calculated boundary, i.e. based on the condition of the gateway device, a boundary is computed where relay beyond this boundary is no longer beneficial. The boundary may be computed using equation (2) below, where R is the relaying group of relaying devices in region A scoping the neighbourhood and c(g, rᵢ) represents the estimated power consumption between the gateway device g and a relaying device rᵢ. q is a predefined threshold of minimum relaying devices.

$$arg max \{ {Bat}_{g} - {\sum }_{{{r}_{i} ∈ R}_{\vert {r}_{i} \vert > q}} c ( g , {r}_{i} ) \} \qquad ( 2 )$$

The size of the region A is chosen in order to maximise the expected battery life of the gateway device while maintaining at q relaying candidates in the region. Lᵢ is then the normalised value of ø(A)−Δ(rᵢ,g), the difference between the diameter of the region A and the distance between a relaying device dᵢ and the gateway device g.

FIG. 6 shows a sensor, gateway device, relaying device and data server representative of the communications system according to an embodiment of the invention. The sensor, gateway device, relaying device and data server have the functionality to carry out the method of an embodiment of the invention.

The sensor is representative of a sensing/measurement device in a monitoring system and comprises a transmitter, a receiver, a controller, a measurement circuit and a battery. The gateway device comprises a transmitter, a receiver, a controller, a display and a battery. The relaying device is a neighbouring device that has been identified by the gateway device to be part of the relaying group and comprises a transmitter, a receiver, a controller and a battery. The data server is an example of a suitable data server for the monitored data/information to be transferred to and comprises a transmitter, a receiver, a controller and storage.

The transmitter and receiver in any device in the system could be two separate devices or it could be any single device with the capability to transmit and receive data over an air interface, such as a transceiver.

In the sensor, the transmitter is used for sending signals over the air interface, such as monitoring information/data to a gateway device. The receiver is used for receiving any signals that may be sent to the sensor, such as sensing controls and instructions (for example, sensing on/off).

In the gateway device, the transmitter is used to transmit data/information, such as the monitoring information received from sensors in the system. When the system is not in the relay stage, the data/information is transmitted directly to the data server (possibly via a base station—not shown). When there is a risk of the direct communication between the gateway device and the data server being lost, the transmitter transmits an alert, initiating the relay stage, to the data server. The transmitter also transmits a handshake message to the neighbouring devices. During the relay stage, the data/information received from the sensor(s) is encrypted and transmitted to a subset of the relaying group to be relayed to the data server. The receiver is responsible for receiving the data/information from the sensor(s). When the relay stage is initiated, the receiver receives the public key from the data server. It also receives the responses to the handshake requests sent to the neighbouring devices.

In the relaying device of the relaying group, the transmitter transmits a response to a handshake request received from the gateway device and transmits the segments of the encrypted data/information received from the gateway device to be relayed to the data server. The receiver receives the said handshake request and the encrypted data/information from the gateway device.

In the data server, the transmitter is responsible for transmitting a public key to the gateway device in response to the alert received from the gateway device. The receiver receives said alert. It also receives the data/information of the sensor(s) in the system. When the system is not in the relay stage, the data/information is received from the gateway device. When in the relay stage, encrypted data/information is received in segments from the relaying devices of the relaying group.

The controller in the sensor, gateway device, relaying device or data server in the system may be any device that is capable of data collection, management and analysis such as a processor. The exact capabilities of the controller will vary depending on the tasks required of the controller.

In the sensor, the controller collects data/information from the measurement circuit and packages the data/information to be transmitted. The controller also analyses any received signals and executes any received instructions.

In the gateway device, the controller collects and packages the received monitoring data/information. The controller also determines whether the communication between the gateway device and the data server is at risk and generates an alert to initiate the relay stage if the communication is at risk. When in the relay stage, the controller generates a handshaking request to be sent to neighbouring devices and then, using the information received in response to the handshaking request, identifies a relaying group of two or more neighbouring devices that can relay the monitoring data/information to the data server. The controller also divides the monitoring data/information into an appropriate number of segments and encodes each of the segments with the public key that was received from the data server at the start of the relay stage.

In the relaying device of the relaying group, the controller generates the information in response to the handshaking request that is issued by the gateway device in the relay stage. The controller also forwards the received encrypted segments of monitoring data/information to the data server and responds to other communications that may be received from other devices, such as the gateway device or the data server.

In the data server, when the system is not in the relay stage, the controller is responsible for processing and storing the received data/information received from the gateway device (possibly via a base station). In the relay stage, the controller is responsible for generating a public and private key pair in response to an alert received from the gateway device. The public key is sent to the gateway device and the private key is stored in the data server. The controller also processes and stores the encrypted segments of data/information received from the relaying devices of the relaying group during the relay stage. Specifically, the controller decodes and combines the received segments using the private key to acquire and then store the monitoring data/information.

The measurement circuit in the sensor in FIG. 6 represents the sensing capabilities of the sensor and may consist of a single element or a number of elements. The measurement circuit is responsible for sensing/measuring or otherwise acquiring the data/information that the sensor is monitoring. The measurement circuit and the data/information to be sensed will be dependent on the sensor and the application of the monitoring system.

The display shown in the gateway device is not necessary for the general embodiment of the invention, but shown for context and completeness. The presence of a display will be dependent on the gateway device. For example, a gateway device that is a mobile phone or smart phone is likely to comprise a display which may be used to display the monitoring data/information received from the sensor(s). Again, this is application dependent and is not a necessity.

The storage shown in the data server is any appropriate storage or memory that may be included in a data server. The storage stores the received data/information of the monitoring system. It also stores the private key that is generated when the relay stage is initiated. The size and configuration of the storage will depend on the particular data server. It is assumed that the data server (or equivalent device) is suitable for the communications system. The specific settings of the data server are not relevant to the invention embodiments and so are not discussed further.

The batteries shown in the sensor, gateway device and relaying devices are representative of power supplies to the devices. Batteries are shown as example power supplies but the actual power supply in each device may be some other suitable power supply and will be dependent on the monitoring system itself and its application.

The communication and selection/screening algorithm may be implemented as mobile applications on the operating system (for example, iOS or Android) of the gateway device. The applications client should have access to low-level hardware information of the device and access to information about the network.

Participation in such a data relay solution may be achieved through consent with the mobile users beforehand, through a real-time questionnaire, or implicit if the users already opt to participate in a network carrier data sharing scheme in general. For explicit opt-in users, the incentive of participating in such a scheme can be monetising their air-time allowance and/or credit for data relay should they themselves fall into such situation. Nonetheless, discussion of this aspect of the implementation is beyond the scope of this patent application.

System and data security will be an important factor in relaying solutions, such as the one set out above. Data relay can incur malicious attacks on the receiving device and the relayed data can become vulnerable. In the proposed embodiments, security could be handled at the application layer (by the mobile as well as base station applications). Basic authentication and encryption measures can also be applied. These measures include such methods as data package encryption, data integrity check, authentication of relay participating devices and/or garbage collection.

Embodiments of the present invention may be able to help maintain constant data collection and monitoring through data relay communication, and/or ensure data quality through data replication over network default settings, and/or provide extra security through segment-based anonymisation.

1. A communications system comprising a gateway device, a data server and neighbouring devices neighbouring the gateway device, wherein
the gateway device is arranged to receive monitoring information from one or more sensors and to forward the monitoring information to the data server;
the data server is arranged to receive the monitoring information;
the communications system is arranged to generate an alert and initiate relaying if the connection between the gateway device and the data server is at risk;
the gateway device is arranged to identify a relaying group of one or more neighbouring devices that can relay the monitoring information from the gateway device to the data server; and to send the monitoring information to the one or more neighbouring devices in the relaying group;
each member of the relaying group is arranged to receive the monitoring information sent to it, and to relay the monitoring information to the data server; and
the data server is arranged to receive the monitoring information.

2. A communication system according to claim 1, wherein
the gateway device is arranged to identify a relaying group of two or more neighbouring devices that can relay the monitoring information from the gateway device to the data server; and to divide the monitoring information into segments and to send each of the segments to a subset of the neighbouring devices in the relaying group;
each member of the relaying group is arranged to receive the segments sent to it, and to relay the segments to the data server; and
the data server is arranged to receive the segments and to combine the segments to acquire the monitoring information.

3. A communication system according to claim 1, wherein
the security component of the data server is arranged to create a public and private key pair in response to the alert and to send the public key to the gateway device;
the gateway device is arranged to encode the monitoring information with the public key; and
the data server is arranged to decode the monitoring information using the private key.

4. A communication system according to claim 1, wherein
each subset includes more than one neighbouring device, and the subsets differ so that no neighbouring device receives all the segments.

5. A communication system according to claim 1, wherein
a shared key is generated for use by the relaying group and gateway device;
the gateway device is arranged to encode each segment with the public key and with the shared key; and
each member of the relaying group is arranged to decrypt the data using the shared key before transmission to the data server.

6. A communication system according to claim 1, wherein
the gateway device is arranged to identify if the connection between the gateway device and the data server is at risk of being lost using a periodical health check which assesses current battery charge and expected battery usage.

7. A communication system according to claim 6, wherein
the periodical health check takes into account one or more of:
a battery level of the gateway device;
power consumption of any essential system applications of the gateway device;
power consumption required to maintain communication with the sensor; and
power consumption required to maintain communication with the data server.

8. A communication system according to claim 6, wherein
the periodical health check uses a battery-usage prediction model to decide whether to initiate relaying.

9. A communication system according to claim 8, wherein
relaying is initiated taking into account one or both of:
historical power consumption of the gateway device; and
location of the gateway device.

10. A communication system according claim 9, wherein
relaying is initiated based on whether the connection will be lost using a current battery-usage based prediction, and/or a historical battery-usage based prediction to provide an estimate of remaining battery life, and wherein the estimate is compared with a threshold to judge if the connection will be lost.

11. A communication system according to claim 10, wherein
both a current battery-usage based prediction and a historical battery-usage based prediction are used, and wherein the threshold is adjusted if the current battery-usage deviates from the pattern of historical battery-usage.

12. A communication system according to claim 10, wherein the historical and/or current battery-usage based predictions include location of an individual being monitored and wherein the prediction whether the connection will be lost takes into account the location of the individual.

13. A communication system according to claim 1, wherein
the gateway device is arranged to identify the relaying group of one or more neighbouring devices that can relay the monitoring information from the gateway device to the data server by broadcasting a handshaking request and deriving neighbour information from responses of candidate neighbouring devices that respond, wherein the neighbour information is used to select neighbouring devices in the relaying group from the candidate neighbouring devices.

14. A communication system according to claim 13, wherein
the neighbour information derived from each neighbour response includes one or more of:
signal strength of the response;
battery life of the candidate neighbouring device;
network carrier used by the candidate neighbouring device;
distance between the gateway device and the candidate neighbouring device; and
operating system of the candidate neighbouring device.

15. A communication system according to claim 13, wherein
the candidate neighbouring devices that respond are ranked giving higher scores to candidate neighbouring devices with longer battery life, stronger signal strength, shorter distance to the gateway device and an operating system compatible with the gateway device.

16. A communication system according to claim 13, wherein
the candidate neighbouring devices that respond but are beyond a boundary distance from the gateway device are not ranked.

17. A communication system according to claim 1, wherein
pre-relaying communication between the gateway device and the data server is via a base station and/or wherein
relaying communication between at least one of the neighbouring devices and the data server is via a base station.

18. A communication system according to claim 1, wherein
the gateway device is a mobile communications device, such as a mobile telephone and/or wherein
the transmission to the neighbouring devices is via short-range wireless technology, such as Bluetooth.

19. A communication system according to claim 1, wherein
at least one of the neighbouring devices is a mobile communications device, such as a mobile telephone.

20. A method of providing consistent monitoring via a communications system, comprising
a gateway device sending monitoring information received from a sensor to a data server, wherein
if the connection between the gateway device and the data server is at risk of being lost, relaying is initiated, in which relaying:
the gateway device identifies a relaying group of one or more neighbouring devices that can relay the monitoring information from the gateway device to the data server;
the gateway device and sends the monitoring information to the one or more neighbouring devices of the relaying group;
each member of the relaying group sends the monitoring information it has received to the data server; and
the data server receives the monitoring information.

21. A gateway device in a communication system, the system comprising the gateway device, a data server and neighbouring devices neighbouring the gateway device, wherein
the gateway device includes a receiver arranged to receive monitoring information from a sensor and a transmitter arranged to forward the monitoring information to the data server;
the gateway device includes a controller arranged to identify a relaying group of one or more neighbouring devices that can relay the monitoring information from the gateway device to the data server; and
the gateway device transmitter is arranged to send the monitoring information to the one or more neighbouring devices of the relaying group.

22. A gateway device according to claim 21, wherein
the gateway device controller is arranged to identify if the connection between the gateway device and the data server is at risk of being lost and if so to trigger a relay stage and generate an alert which is sent to the data server.

23. A method in a gateway device of a communication system, the system comprising the gateway device, a data server and neighbouring devices neighbouring the gateway device, the method including
receiving monitoring information from a sensor and forwarding the monitoring information to the data server;
identifying a relaying group of one or more neighbouring devices that can relay the monitoring information from the gateway device to the data server; and
sending the monitoring information to the one or more neighbouring devices of the relaying group.

24. A non-transitory, machine-readable storage device storing a computer program which when executed on a mobile device, carries out a method in a gateway device of a communication system, the system comprising the gateway device, a data server and neighbouring devices neighbouring the gateway device, the method including
receiving monitoring information from a sensor and forwarding the monitoring information to the data server;
identifying a relaying group of one or more neighbouring devices that can relay the monitoring information from the gateway device to the data server; and
sending the monitoring information to the one or more neighbouring devices of the relaying group.
